(19) United States
(12) Patent Application Publication
(10) Pub. No.: US 2011/0109564 A1
(43) Pub. Date: May 12, 2011

(54) TOUCH SCREEN INPUT DEVICE AND METHOD OF MANUFACTURING THE SAME

(76) Inventors: Jong Young Lee, Gyunggi-do (KR); Young Soo Oh, Gyunggi-do (KR); Ho Joon Park, Seoul (KR); Sang Hwa Kim, Gyunggi-do (KR)

(21) Appl. No.: 12/642,234

(22) Filed: Dec. 18, 2009

(30) Foreign Application Priority Data
Nov. 9, 2009 (KR) 10-2009-0107696

(51) Int. Cl. G06F 3/041; B05D 5/12; B32B 37/00

(52) U.S. Cl. 345/173; 427/64; 156/60

(57) ABSTRACT

Disclosed is a touch screen input device, which includes a window plate through which a signal is input, a conductive film applied on one surface of the window plate using a conductive polymer, a first adhesive layer applied on one surface of the conductive film, and an anti-noise film applied on one surface of the first adhesive layer using a conductive polymer and thus grounded, so that the conductive film is directly applied on the window plate, thus omitting bonding of an additional film coated with a conductive film to the window plate, thereby preventing the generation of foam and simplifying the manufacturing process. A method of manufacturing the touch screen input device is also provided.

### CROSS REFERENCE TO RELATED APPLICATION

This application claims the benefit of Korean Patent Application No. 10-2009-0107696, filed Nov. 9, 2009, entitled “Input device of touch screen and a method for manufacturing the same”, which is hereby incorporated by reference in its entirety into this application.

### BACKGROUND OF THE INVENTION

1. Technical Field

The present invention relates to a touch screen input device and a method of manufacturing the same.

2. Description of the Related Art

The digital technology with which computers have been developed is also leading to the concomitant development of assistant devices. Furthermore, personal computers, portable transporters and other personal information processors are responsible for text and graphic processing using a variety of input devices, including a keyboard, a mouse, a digitizer and so on.

However, because the end uses for which computers are used are becoming more and more diversified alongside the rapid advancement of the information society, the use of only a keyboard and a mouse as input devices which play a role as interfaces is causing problems of making the efficient operation of products difficult. Thus, there may be an increased demand for an input device which is simple to configure and has fewer erroneous operations and to which information is easily input by anyone, in particular, information may be input by the hand of a user in a state of the user carrying such a device.

Also, current technology concerning input devices is going beyond the level of satisfying the needs regarding typical functions and is making progress about high reliability, durability, innovative behavior, designing and manufacturing. To this end, a touch screen has been developed as an input device which enables the input of information such as text or graphics.

The touch screen is mounted on the display surface of an image display device such as an electronic organizer, a flat display device including a liquid crystal display (LCD), a plasma display panel (PDP), an electroluminescence (El) element or the like, or a cathode ray tube (CRT), so that a user selects desired information while viewing the image display device. The touch screen is classified into a resistive type, a capacitive type, an to electromagnetic type, a SAW type and an infrared type.

These types of touch screens are selected to be adapted for respective electronic products in consideration of not only signal amplification problems, resolution differences and the degree of difficulty of designing and manufacturing technology but also in light of optical properties, electrical properties, mechanical properties, environment resistance, input properties, durability and economic benefits of the touch screen. In particular, resistive and capacitive types are prevalently used in electronic organizers, PDAs, portable PCs and mobile phones.

Among the types of touch screens, the capacitive type operates in response to changes in capacitance occurring upon contact being made with the body of a user or a specific object. Specifically, when this touch screen comes into contact with the body of a user or a specific object under conditions in which voltage is applied and high frequency is thus applied onto the entire surface of the conductive film, a controller thereof senses the deformed wave form and thus recognizes the position. Unlike the resistive type, the capacitive type does not deform the touch screen, thus preventing the generation of the distortion of the image, and also, is superior in terms of durability and sensitivity. However, the capacitive type touch screen according to the conventional technique has some problems.

FIG. 1 shows a process of manufacturing the capacitive type touch screen according to the conventional technique. With reference to this drawing, the problems of the conventional technique are described below.

As shown in FIG. 1, the method of manufacturing the touch screen 20 according to the conventional technique includes separately manufacturing an ITO film 10 and a window plate 6, followed by bonding the finally manufactured ITO film 10 and window plate 6 to each other, thus completing the touch screen 20.

Specifically, manufacturing the ITO film 10 includes depositing indium tin oxide (ITO) 2 on a film 1, forming an ITO pattern 3 using photolithography, forming electrodes 4 on the ITO pattern 3, applying a pressure sensitive adhesive 5 on the ITO pattern 3 and the electrodes 4, and connecting a flexible printing cable 7 to the electrodes 4. Then, the window plate 6 is bonded to the upper surface of the ITO film 10 thus manufactured, thereby completing the touch screen 20.

However, the capacitive type touch screen 20 manufactured by the above process is problematic because the ITO film 10 manufactured by depositing the ITO 2 on the film 1 should be bonded again to the window plate 6 which is positioned at the outermost surface of the touch screen 20, and thus foam may occur between the ITO film 10 and the window plate 6 upon bonding, undesirably resulting in a bad touch screen 20.

Furthermore, the bonding of the ITO film 10 to the window plate 6 requires an additional device, and as well, an additional process, undesirably complicating the manufacturing process.

Moreover, in the formation of the ITO pattern 3 using photolithography after the deposition of the ITO 2 on the film 1, photolithography including the procedural series of deposition, masking, exposure, development, etching and stripping is required, and thus consumption of the raw material ITO 2 is increased and the manufacturing process is rendered complicated.

### SUMMARY OF THE INVENTION

Accordingly, the present invention has been made keeping in mind the problems encountered in the related art and the present invention is intended to provide a touch screen input device and a method of manufacturing the same, in which a conductive polymer is directly applied on a window plate to form a conductive film, and thus bonding of an additional film coated with a conductive film to a window plate can be omitted, thereby preventing the production of a bad touch screen and simplifying the manufacturing process.

An aspect of the present invention provides a touch screen input device, including a window plate through which a signal is input, a conductive film applied on one surface of the window plate using a conductive polymer, a first adhesive layer applied on one surface of the conductive film, and an anti-noise film applied on one surface of the first adhesive layer using a conductive polymer and thus grounded.

Also, the touch screen input device may further include a second adhesive layer applied on one surface of the anti-noise film and an image display device attached to one surface of the second adhesive layer.

Also, the touch screen input device may further include electrodes printed on an edge of one surface of the conductive film.

In this aspect, the window plate may include polyethyleneterephthalate, polycarbonate, polymethylmethacrylate, polyethylenenaphthalate, polyethersulfone, a cyclic olefin polymer, glass or reinforced glass.

In this aspect, the conductive polymer may include poly-3,4-ethylenedioxythiophene/polystyrenesulfonate or polyaniline.

In this aspect, the conductive film or the anti-noise film may be applied by ink-jet printing, gravure printing, offset printing, or silk screen printing. In this aspect, the conductive polymer may have a sheet resistance ranging from 200 Ω/sq to 700 Ω/sq.

In this aspect, the first adhesive layer may include an optical clear adhesive or a double-sided adhesive tape.

In this aspect, the second adhesive layer may include an optical clear adhesive or a double-sided adhesive tape.

Another aspect of the present invention provides a method of manufacturing the touch screen input device, including (A) coating one surface of a window plate, through which a signal is input, with a conductive film using a conductive polymer, (B) applying a first adhesive layer on one surface of the conductive film and (C) coating one surface of the first adhesive layer with an anti-noise film using a conductive polymer, so that the anti-noise film is grounded.

The method may further include applying a second adhesive layer on one surface of the anti-noise film and attaching an image display device to one surface of the second adhesive layer, after (C).

In this aspect, (A) may further include printing electrodes on an edge of one surface of the conductive film.

In this aspect, in (A), the window plate may include polyethyleneterephthalate, polycarbonate, polymethylmethacrylate, polyethylenenaphthalate, polyethersulfone, a cyclic olefin polymer, glass or reinforced glass.

In this aspect, in (A) or (C), the conductive polymer may include poly-3,4-ethylenedioxythiophene/polystyrenesulfonate or polyaniline.

In this aspect, in (A) or (C), the conductive film or the anti-noise film may be applied by ink-jet printing, gravure printing, offset printing, or silk screen printing.

In this aspect, in (A) or (C), the conductive polymer may have a sheet resistance ranging from 200 Ω/sq to 700 Ω/sq.

In this aspect, in (B), the first adhesive layer may include an optical clear adhesive or a double-sided adhesive tape.

In this aspect, the second adhesive layer may include an optical clear adhesive or a double-sided adhesive tape.

### BRIEF DESCRIPTION OF THE DRAWINGS

The features and advantages of the present invention will be more clearly understood from the following detailed description taken in conjunction with the accompanying drawings, in which:

FIG. 1 is of cross-sectional views sequentially showing a process of manufacturing a capacitive type touch screen according to a conventional technique;

FIGS. 2A, 2B, 3A and 3B are cross-sectional views showing touch screen input devices according to embodiments of the present invention; and

FIGS. 4, 5 and 6A and 6B to 9A and 9B are cross-sectional views sequentially showing a process of manufacturing the touch screen input devices according to the embodiments of the present invention.

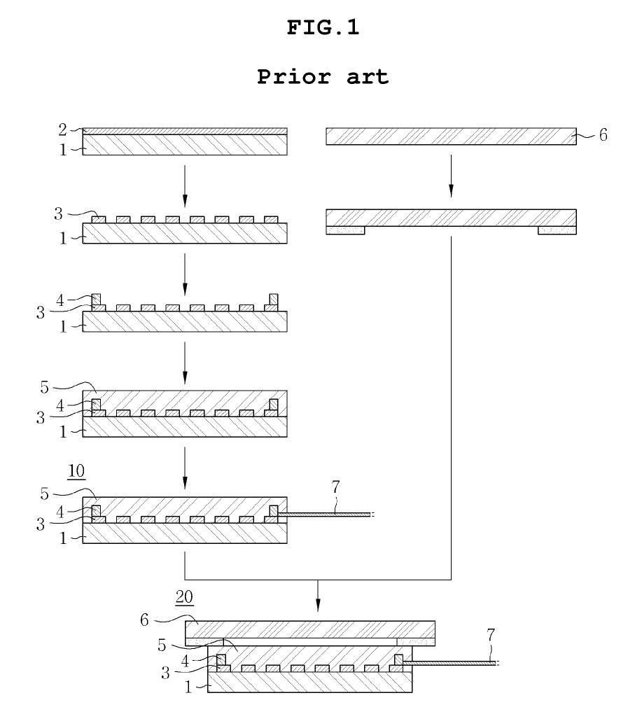

### DESCRIPTION OF SPECIFIC EMBODIMENTS

Hereinafter, embodiments of the present invention will be described in detail while referring to the accompanying drawings. Throughout the drawings, the same reference numerals are used to refer to the same or similar elements. In the description, the terms “first”, “second”, “one surface”, “the other surface” and so on are used to distinguish one to element from another element, and the elements are not defined by the above terms. Moreover, descriptions of known techniques, even if they are pertinent to the present invention, are regarded as unnecessary and may be omitted in so far as they would make the characteristics of the invention and the description unclear.

Furthermore, the terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept implied by the term to best describe the method he or she knows for carrying out the invention.

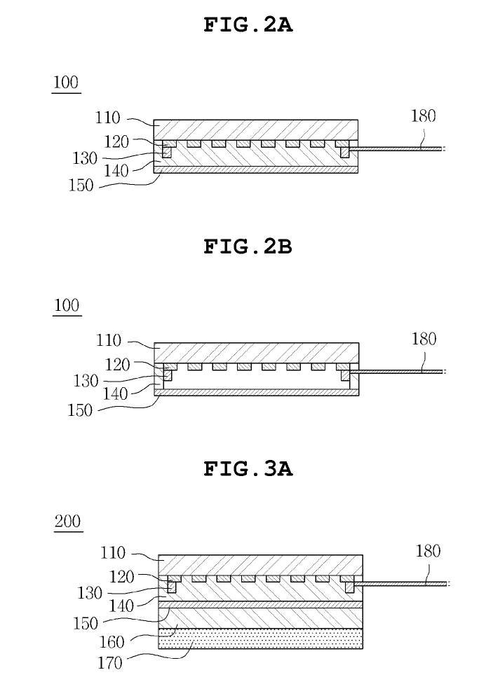

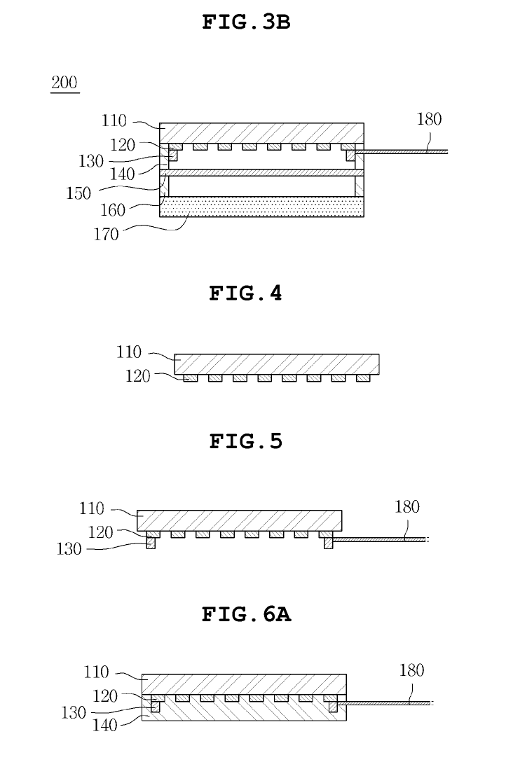

FIGS. 2A, 2B, 3A and 3B are cross-sectional views showing touch screen input devices according to embodiments of the present invention.

As shown in FIGS. 2A and 2B, the touch screen input device 100 according to the present embodiment includes a window plate 110 through which a signal is input, a conductive film 120 applied on one surface of the window plate 110 using a conductive polymer, a first adhesive layer 140 applied on one surface of the conductive film 120, and an anti-noise film 150 applied on one surface of the first adhesive layer 140 using a conductive polymer. Also, as shown in FIGS. 3A and 3B, the touch screen input device 200 according to the present embodiment may further include a second adhesive layer 160 applied on one surface of the anti-noise film 150 and an image display device 170 attached to one surface of the second adhesive layer 160. Furthermore, FIGS. 2A and 3A illustrate the first adhesive layer 140 and the second adhesive layer 160 using an optical clear adhesive (OCA), and FIGS. 2B and 3B illustrate the first adhesive layer 140 and the second adhesive layer 160 using a double-sided adhesive tape (DAT), as will be described later.

The window plate 110 functions to transmit a touch signal applied by the body of a user or a specific object, and is disposed at the outermost surface of the touch screen input device 100, 200. The window plate 110 which is disposed at the outermost surface of the device should be imparted with durability so as to protect the touch screen input device 100, 200 from external mechanical impact. Also, one surface of the window plate 110 should be able to be coated with the conductive film, and should be transparent so that a user perceives the image provided by the image display device 170. In consideration thereof, the window plate 110 may be made of polyethyleneterephthalate (PET), polycarbonate (PC), polymethylmethacrylate (PMMA), polyethylenenaphthalate (PEN), polyethersulfone (PES) or a cyclic olefin polymer (COC). In addition, the window plate 110 may be made of typically used glass or reinforced glass.

The conductive film 120 functions to recognize the signal input through the window plate 110, and is applied on one surface of the window plate 110. Specifically, the conductive film 120 recognizes changes in value of capacitance and transfers them to a controller (not shown), and the controller converts an analog signal into a digital signal and simultaneously recognizes the coordinates of the pressed position thus realizing the desired operation.

As such, the conductive film 120 is formed by applying the conductive polymer, and examples of the conductive polymer are not particularly limited but include poly-3,4-ethylenedioxythiophene/polystyrenesulfonate (PEDOT/PSS) and polyaniline, which may be used alone or mixed together. The process of coating one surface of the window plate 110 with the conductive film 120 is not particularly limited, but includes for example ink-jet printing, gravure printing, offset printing or silk screen printing. The conductive film 120 may be applied in the form of a pattern such as a rod shape, a triangle shape, a diamond shape or an X-Y cross shape such as is typically employed in capacitive type touch screens. Unlike the conventional technique for coating an additional film with ITO through deposition, development and etching, the conductive film 120 according to the present embodiment is directly applied on the window plate 110 by ink-jet printing, gravure printing, offset printing or silk screen printing using the conductive polymer, thus reducing the use of raw material, simplifying the complicated manufacturing process and omitting the bonding of an additional film to the window plate. Furthermore, the conductive film 120 applied using the conductive polymer may have a sheet resistance of 200˜700 Ω/sq adapted for the capacitive type touch screen.

The first adhesive layer 140 functions as a spacer for insulating the conductive film 120 and the anti-noise film 150 from each other while bonding the conductive film 120 and the anti-noise film 150 to each other, and is applied on one surface of the conductive film 120. Specifically, in the touch screen input device 100, 200 according to the present embodiment, an electrical connection must not form between the conductive film 120 and the anti-noise film 150. To this end, an insulating material is disposed between the conductive film 120 and the anti-noise film 150, and also, a transparent material is disposed therebetween so that a user perceives the image provided by the image display device 170. In consideration of insulating properties and transparency, the first adhesive layer 140 may be made of OCA (FIGS. 2A and 3A) or DAT (FIGS. 2B and 3B).

The anti-noise film 150 functions to prevent the generation of noise, and is applied on one surface of the first adhesive layer 140. As such, the anti-noise film 150 is grounded and thus blocks the generation of noise when recognizing the signal by the conductive film 120. The anti-noise film 150 may be formed using a conductive polymer including poly-3,4-ethylenedioxythiophene/polystyrenesulfonate (PEDOT/PSS) or polyaniline, as in the conductive film 120. Furthermore, the anti-noise film 150 may be formed through ink-jet printing, gravure printing, offset printing or silk screen printing.

The second adhesive layer 160 functions to attach the image display device 170 to the anti-noise film 150. As such, the second adhesive layer 160 should bond the anti-noise film 150 and the image display device 170 to each other and should also be transparent so that a user perceives the image provided by the image display device 170, and thus may be formed of OCA (FIG. 3A) or DAT (FIG. 3B) as in the first adhesive layer 140. The second adhesive layer 160 is used to bond the image display device 170 to the anti-noise film 150, thereby manufacturing an image display device-integrated touch screen and further simplifying the total manufacturing process.

The image display device 170 provides an image able to be perceived by a user, and includes for example an LCD, a PDP, an El element, a CRT, etc., which are typically usable for the touch screen input device.

Moreover, electrodes 130 are printed on the edge of one surface of the conductive film 120. The electrodes 130 function to supply voltage to the conductive film 120, and may be printed by silk screen printing using silver which has high electrical conductivity. Also, a flexible printing cable 180 for connecting the electrodes 130 to an external circuit may be to provided.

FIGS. 4, 5 and 6A and 6B to 9A and 9B sequentially show a process of manufacturing the touch screen input devices according to the embodiments of the present invention.

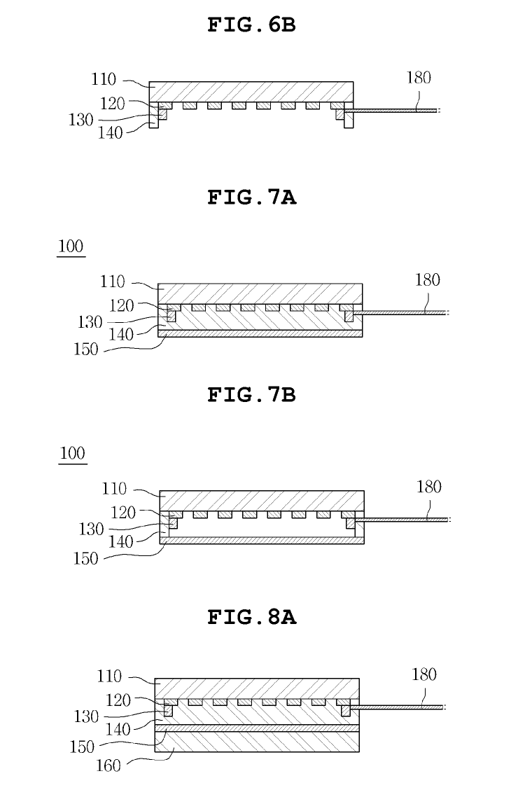

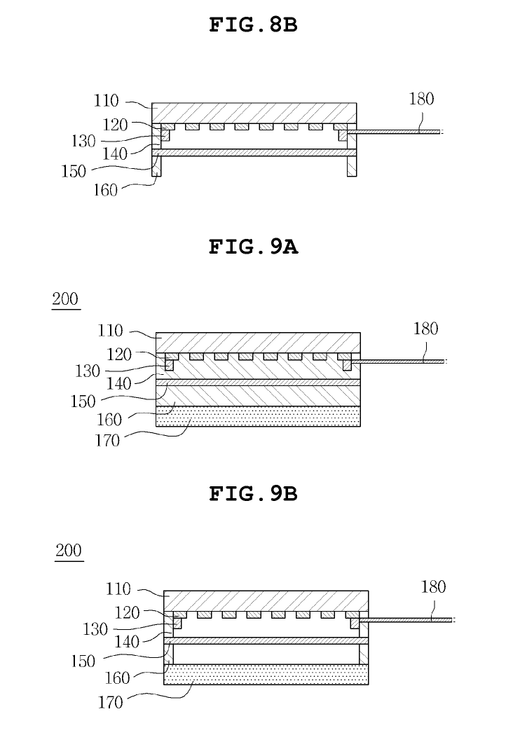

As shown in FIGS. 4, 5 and 6A and 6B to 7A and 7B, the method of manufacturing the touch screen input device 100 according to the present embodiment includes (A) coating one surface of a window plate 110, through which a signal is input, with a conductive film 120 using a conductive polymer, (B) applying a first adhesive layer 140 on one surface of the conductive film 120 and (C) coating one surface of the first adhesive layer 140 with an anti-noise film 150 using a conductive polymer, thus grounding the anti-noise film 150. Also, as shown in FIGS. 8A and 8B to 9A and 9B, the method of manufacturing the touch screen input device 200 according to the present embodiment may further include, after (C), applying a second adhesive layer 160 on one surface of the anti-noise film 150 and attaching an image display device 170 to one surface of the second adhesive layer 160. As such, FIGS. 6A, 7A, 8A and 9A illustrate the first adhesive layer 140 and the second adhesive layer 160 using OCA, and FIGS. 6B, 7B, 8B and 9B illustrate the first adhesive layer 140 and the second adhesive layer 160 using DAT. Both these cases are the same with the exception that the materials used for the first adhesive layer 140 and the second adhesive layer 160 are different.

As shown in FIG. 4, one surface of the window plate 110 is coated with the conductive film 120. As such, the window plate 110 functions to transmit a touch signal, and should thus be durable and transparent. Hence, the window plate 110 may be made of polyethyleneterephthalate (PET), polycarbonate (PC), polymethylmethacrylate (PMMA), polyethylenenaphthalate (PEN), polyethersulfone (PES) or a cyclic olefin polymer (COC). In addition, the window plate 110 may be made of typically used glass or reinforced glass. The conductive film 120 functions to recognize the signal input through the window plate 110, and may be provided in the form of a predetermined pattern using a conductive polymer including poly-3,4-ethylenedioxythiophene/polystyrenesulfonate (PEDOT/PSS) or polyaniline. As such, the conductive polymer may be directly applied on the window plate 110 by ink-jet printing, gravure printing, offset printing or silk screen printing, thus simplifying the manufacturing process and reducing the use of raw material. The sheet resistance of the conductive polymer may range from 200 Ω/sq to 700 Ω/sq adapted for a capacitive type touch screen.

Next, as shown in FIG. 5, the edge of one surface of the conductive film 120 is printed with electrodes 130. As such, the electrodes 130 function to supply voltage to the conductive film 120, and may be formed by printing silver which has high electrical conductivity through silk screen printing. Furthermore, a flexible printing cable 180 may be provided so as to connect the electrodes 130 to an external circuit.

Next, as shown in FIGS. 6A and 6B, the first adhesive layer 140 is applied on one surface of the conductive film 120. As such, the first adhesive layer 140 should insulate the conductive film 120 and an anti-noise film 150 which will be described later from each other while bonding the conductive film 120 and the anti-noise film 150 to each other, and should also be transparent so that a user perceives the image. To this end, the first adhesive layer 140 may be made of OCA (FIG. 6A) or DAT (FIG. 6B).

Next, as shown in FIGS. 7A and 7B, the anti-noise film 150 is applied on the first adhesive layer 140 and is thus grounded. As such, the anti-noise film 150 functions to block the generation of noise when the signal is recognized by the conductive film 120, and may be applied by ink-jet printing, gravure printing, offset printing or silk screen printing using a conductive polymer including poly-3,4-ethylenedioxythiophene/polystyrenesulfonate (PEDOT/PSS) or polyaniline which is the same material as in the conductive film 120, thereby completing the fabrication of the touch screen input device 100. Also, in order to manufacture an image display device-integrated touch screen, the following two procedures should be further performed.

Next, as shown in FIGS. 8A and 8B, the second adhesive layer 160 is applied on one surface of the anti-noise film 150. The second adhesive layer 160 functions to attach the image display device 170 in a subsequent procedure, and the second adhesive layer 160 may be made of OCA (FIG. 8A) or DAT (FIG. 8B), having adhesive force and transparency.

Next, as shown in FIGS. 9A and 9B, the image display device 170 is attached to one surface of the second adhesive layer 160. The image display device 170 provides an image to a user, and includes for example an LCD, a PDP, an El element, a CRT and so on, which may be generally used for a touch screen input device. Thereby, the fabrication of the image display device-integrated touch screen is completed.

As described hereinbefore, the present invention provides a touch screen input device and a method of manufacturing the same. According to the present invention, a conductive film is directly applied on a window plate, and thus bonding of an additional film coated with a conductive film to a window plate can be omitted, thereby preventing the formation of foam and simplifying the manufacturing process.

Also, according to the present invention, the conductive film is applied using a conductive polymer instead of ITO in a conventional technique, thus reducing the use of raw material and simplifying the manufacturing process.

Also, according to the present invention, an anti-noise film which is grounded is employed, thus preventing the generation of noise in a capacitive type touch screen, thereby further enhancing sensitivity of the touch screen which is able to sensitively recognize contact made by the body of a user or a specific object.

Although the embodiments of the present invention regarding the touch screen input device and the method of manufacturing the same have been disclosed for illustrative purposes, those skilled in the art will appreciate that a variety of different modifications, additions and substitutions are possible, without departing from the scope and spirit of the invention as disclosed in the accompanying claims. Accordingly, such modifications, additions and substitutions should also be understood as falling within the scope of the present invention.

What is claimed is:

1. A touch screen input device, comprising:
a window plate through which a signal is input;
a conductive film applied on one surface of the window plate using a conductive polymer;
a first adhesive layer applied on one surface of the conductive film; and
an anti-noise film applied on one surface of the first adhesive layer using a conductive polymer and thus grounded.

2. The touch screen input device as set forth in claim 1, further comprising:
a second adhesive layer applied on one surface of the anti-noise film; and
an image display device attached to one surface of the second adhesive layer.

3. The touch screen input device as set forth in claim 1, further comprising electrodes printed on an edge of the one surface of the conductive film.

4. The touch screen input device as set forth in claim 1, wherein the window plate comprises polyethyleneterephthalate, polycarbonate, polymethylmethacrylate, polyethylenenaphthalate, polyethersulfone, a cyclic olefin polymer, glass or reinforced glass.

5. The touch screen input device as set forth in claim 1, wherein the conductive polymer comprises poly-3,4-ethylenedioxythiophene/polystyrenesulfonate or polyaniline.

6. The touch screen input device as set forth in claim 1, wherein the conductive film or the anti-noise film is applied by ink-jet printing, gravure printing, offset printing, or silk screen printing.

7. The touch screen input device as set forth in claim 1, wherein the conductive polymer has a sheet resistance ranging from 200 Ω/sq to 700 Ω/sq.

8. The touch screen input device as set forth in claim 1, wherein the first adhesive layer comprises an optical clear adhesive or a double-sided adhesive tape.

9. The touch screen input device as set forth in claim 2, wherein the second adhesive layer comprises an optical clear adhesive or a double-sided adhesive tape.

10. A method of manufacturing a touch screen input device, comprising:
(A) coating one surface of a window plate, through which a signal is input, with a conductive film using a conductive polymer;
(B) applying a first adhesive layer on one surface of the conductive film; and
(C) coating one surface of the first adhesive layer with an anti-noise film using a conductive polymer, so that the anti-noise film is grounded.

11. The method as set forth in claim 10, further comprising applying a second adhesive layer on one surface of the anti-noise film and attaching an image display device to one surface of the second adhesive layer, after (C).

12. The method as set forth in claim 10, wherein (A) further comprises printing electrodes on an edge of the one surface of the conductive film.

13. The method as set forth in claim 10, wherein in (A) the window plate comprises polyethyleneterephthalate, polycarbonate, polymethylmethacrylate, polyethylenenaphthalate, polyethersulfone, a cyclic olefin polymer, glass or reinforced glass.

14. The method as set forth in claim 10, wherein in (A) or (C) the conductive polymer comprises poly-3,4-ethylenedioxythiophene/polystyrenesulfonate or polyaniline.

15. The method as set forth in claim 10, wherein in (A) or (C) the conductive film or the anti-noise film is applied by ink-jet printing, gravure printing, offset printing, or silk screen printing.

16. The method as set forth in claim 10, wherein in (A) or (C) the conductive polymer has a sheet resistance ranging from 200 Ω/sq to 700 Ω/sq.

17. The method as set forth in claim 10, wherein in (B) the first adhesive layer comprises an optical clear adhesive or a double-sided adhesive tape.

18. The method as set forth in claim 11, wherein the second adhesive layer comprises an optical clear adhesive or a double-sided adhesive tape.
